(19) United States
(12) Patent Application Publication
(10) Pub. No.: US 2014/0358865 A1
(43) Pub. Date: Dec. 4, 2014

(54) PROCESSING A TECHNICAL SYSTEM

(71) Applicants: Hans-Gerd Brummel, Berlin (DE); Stephan Grimm, Munchen (DE); Thomas Hubauer, Munchen (DE); Mikhail Roshchin, Feldkirchen (DE); Michael Watzke, Munchen (DE)

(72) Inventors: Hans-Gerd Brummel, Berlin (DE); Stephan Grimm, Munchen (DE); Thomas Hubauer, Munchen (DE); Mikhail Roshchin, Feldkirchen (DE); Michael Watzke, Munchen (DE)

(21) Appl. No.: 14/369,826

(22) PCT Filed: Dec. 28, 2011
(86) PCT No.: PCT/EP2011/074144

§ 371 Date: Aug. 6, 2014

(51) Int. Cl. G06F 17/30

(52) U.S. Cl. CPC G06F 17/30424; G06F 17/30371
USPC 707/687; 707/722; 707/769

(57) ABSTRACT

Rules of a rule base are transformed in an automated fashion in order to be able to conduct consistency checks and generate explanations and thus classify and correct existing rules. This is beneficial in particular in large systems with existing rule bases, e.g., wherein each rule is associated with at least a diagnostic task of a component of a technical system, e.g., a power system. The task can be subject to fault detection, fault isolation, predictive diagnosis or reporting. The solution presented provides an overview of large sets of rules and thus allows determining which rules are suitable and which are not. The invention is applicable for all kinds of technical systems, e.g., industry and automation systems, in particular power systems.

The invention relates to a method and to a device for processing a technical system, in particular a power system. In addition, an according computer program product and a computer-readable medium are suggested.

The article [Hubauer et al.: Relaxed Abduction: Robust Information Interpretation for Incomplete Models, CEUR Workshop Proceedings, published Jul. 8, 2011, link: http://ceur-ws.org/Vol-745/paper_{—}48.pdf] introduces relaxed abduction, a reasoning task for description logics. Based on known abductive reasoning techniques, this relaxed abduction approach provides adequate results when only spurious information or incomplete models exist. The abductive reasoning approach handles incomplete observations and models automatically based on a joint optimization of the sets of explained observations and required assumptions. This article is also referred to as Relaxed-Abduction Article hereinafter.

Description logics (DLs) are a family of formal knowledge representation languages. Typical DLs are more expressive than propositional logic but, other than first-order predicate logic, decidable. They are used in artificial intelligence for formal reasoning on the concepts of an application domain (known as terminological knowledge). This is of particular importance in providing a logical formalism for ontologies and the Semantic Web. For further detail, reference is made, e.g., to http://en.wikipedia.org/wiki/Description_logic.

An ontology formally represents knowledge as a set of concepts within a domain, and the relationships between these concepts. It can be used to reason about the entities within that domain and may be used to describe the domain. In theory, an ontology can be understood as a “formal, explicit specification of a shared conceptualization”. An ontology renders shared vocabulary and taxonomy which models a domain with the definition of objects and/or concepts and their properties and relations. For further detail, reference is made, e.g., to http://en.wikipedia.org/wiki/Ontology_%28computer_science%29.

Rule-based systems are used in various industrial applications such as expert systems and diagnostic units. The underlying rule bases can be large and complex, encompassing thousands of rules with intricate interactions which are not known explicitly, but result from atoms shared among the rules.

For example, in a power diagnostic center, such a rule base may comprise several thousands of rules, each rule being responsible for some specific diagnostic task of, e.g., a gas turbine. Administration tasks in existing systems are conducted in a manual fashion by human personnel. Hence, administration of rules is difficult, error-prone and time-consuming.

It is quite possible that, given a certain set of input data, a technician expects a certain set of rules to “fire”, i.e. to be activated (indicating, for example, a certain failure being detected), but the system does not produce such expected behavior. Typical reasons for this can be overly specific preconditions, or “near” misses on predicates that depend on numerical values.

The objective is thus to overcome such disadvantages and in particular to refine and/or administer a large set of rules for a technical system.

This problem is solved according to the features of the independent claims. Further embodiments result from the depending claims.

In order to overcome this problem, a method is provided for processing a technical system,
wherein rules of a rule base are transformed into axioms,
wherein a query based on said axioms is processed by a reasoning component.

Axioms can be used for describing a technical system, in particular a model of the technical system, wherein complex relationships can be expressed by temporal and/or spatial dependencies. Assumptions can be regarded as abducibles or abducible axioms. Said axioms can be used for deriving consistency checks and/or for generating explanations. This can be achieved by means of deduction (see, e.g., concept of deductive reasoning as indicated in, e.g., http://en.wikipedia.org/wiki/Deductive_reasoning) and/or by abduction, in particular by a relaxed abduction (see Relaxed-Abduction Article as mentioned above).

The rule base may be a set of existing rules of the technical system. The rules may be directed to, e.g., diagnostic tasks. The tasks may be of various kinds, e.g., fault detection, fault isolation, (predictive) diagnosis, reporting, measurement, etc. The rule base may also comprise a basic knowledge base known to operators or human personal that is transformed into axioms.

The solution presented provides an overview of large sets of rules and thus allows determining which rules are suitable and which are not.

The query can be any information provided to the reasoning component (e.g., pushed to or polled by the reasoning component) based on the axioms; the query may, e.g., comprise axioms or information based on the axioms. In other words, the processing at the reasoning component may be conducted at least partially based on the axioms that stem from the transformed rules of the rule base. The reasoning component may be any reasoning functionality provided in a system, e.g., a diagnosis or debugging system.

Hence, complex systems can be administered in an automated way, rules can be classified and optimized and a complex rule base can become more transparent as well as more effective. The solution in particular supports and enables an automated debugging of complex rule bases.

Technical systems comprise several components, e.g., rotating equipment, generators, etc., that are subject to diagnosis, supervision and/or maintenance. The technical system may be or comprise at least one of the following: a rotating device, a power unit, a generator, a supply chain, a manufacturing system, a delivery system, an industrial system or the like.

The solution presented provides a solution to automatically identify failed rule premises and, thus potentially flawed rules, based on, e.g., historical sensor data and/or information on rules that are expected to fire provided by a technician. As sensor data are typically temporal in nature (i.e. measurement have associated timestamps), this analysis can be provided for each relevant time slice (which can be detected and processed automatically).

In an embodiment, the rules of the rule base are translated into a rule interchange format and then the translated rules are transformed into axioms.

Hence, a commonly format for rules could be used as an intermediate step prior to transforming the rules into axioms. Advantageously, the rule interchange format provides a more efficient way for generating axioms compared to rules that are available only in, e.g., a proprietary way.

In another embodiment, transforming the rules into axioms comprises at least one of the following steps:
parsing of the rules;
providing an object-based rule representation;
providing a graph-based rule representation;
serializing the rules;
creating or modifying of at least one model based on the rules;
transforming the rules into a description language, in particular in EL+.

In a further embodiment, a debugging component is provided prior to the reasoning component, wherein said axioms are fed to the debugging component and the debugging component compiles said query for the reasoning component.

It is noted that “component” according to this description may in particular refer to a functionality (e.g., functional block) or portion of a software implementation that provides a particular functionality or service. Although that being an option, the component does not necessarily have a separate physical representation or device, it may, e.g., be a logical functionality. In this sense, a first component being “prior” to a second component reflects the possibility that a first functionality is provided before a second functionality. Hence, the ways the implementation is structured or realized, e.g., with regard to physical entities, may be various.

It is also an embodiment that the debugging component provides at least one of the following steps:
parsing of the axioms;
time slicing of data provided by at least one sensor and/or a set of basic assumptions;
conveying the query to the reasoning component.

Pursuant to another embodiment, the debugging component utilizes a description language, in particular EL+.

According to an embodiment, the reasoning component conducts at least one of the following steps:
conduct a consistency check in particular by conducting a deduction;
generate an explanation in particular by conducting an abduction, in particular a relaxed abduction.

According to another embodiment, said reasoning component conducts the consistency check and/or generates an explanation based on OWL axioms utilizing a description logic, in particular EL+.

The problem stated above is also solved by a device for processing a technical system comprising a processing unit that is arranged for
transforming rules of a rule base into axioms,
processing a query based on said axioms by a reasoning component.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

According to an embodiment, the device is an administration, a debugging or a diagnosis device of the technical system.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a system comprising at least one device as described herein.

The aforementioned characteristics, features and advantages of the invention as well as the way they are achieved will be further illustrated in connection with the following examples and considerations as discussed in view of the figures.

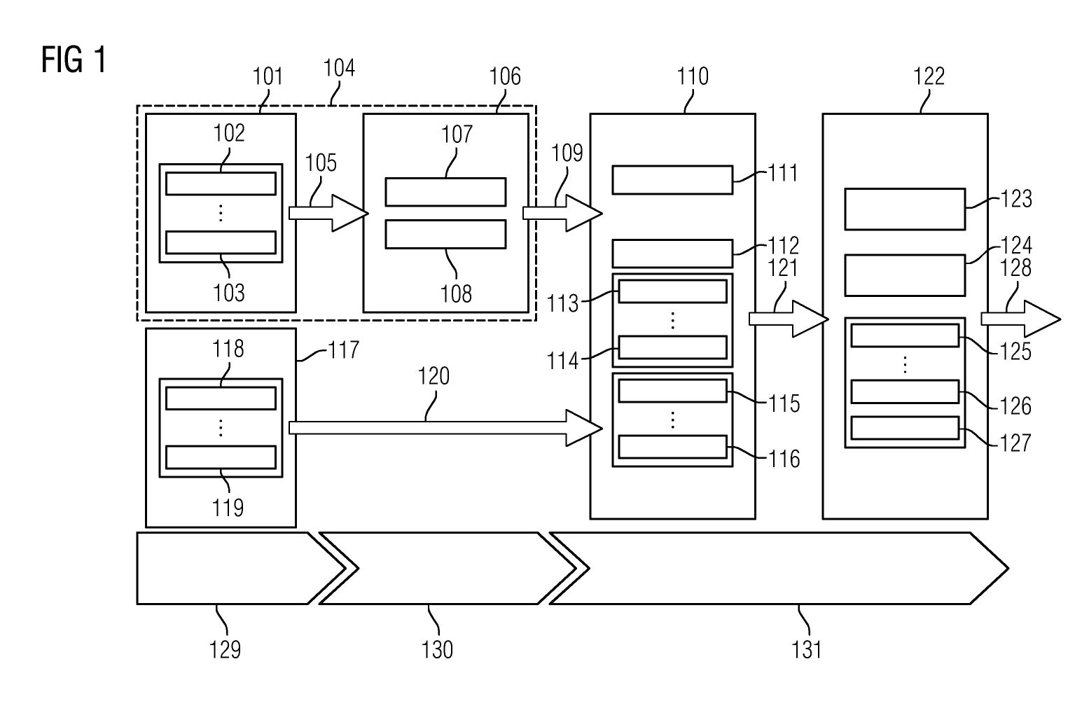

FIG. 1 shows a schematic diagram visualizing the concept of an automated debugging of a rule base;

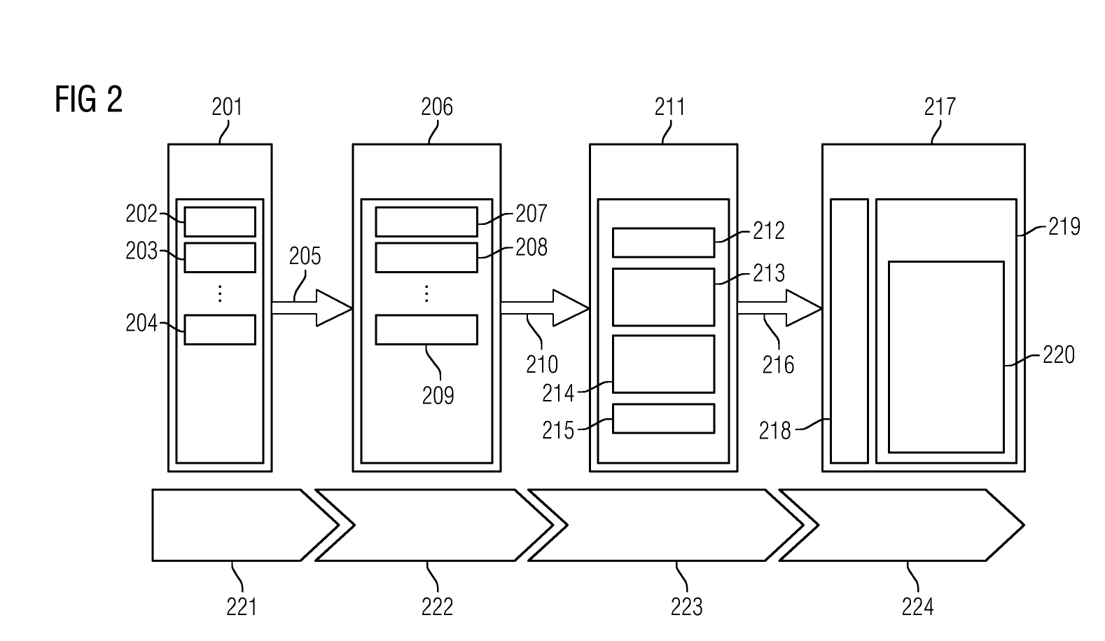

FIG. 2 shows an exemplary concept of an automated classification and consistency checking mechanism of a rule base.

It is suggested utilizing an abductive reasoning approach, in particular a so-called relaxed abduction, to provide an automated approach for debugging of an extensive rule base.

First, the rule base is automatically translated into a set of logically equivalent axioms (specifically, the causal or anti-causal nature of the axioms is preserved).

Then, measurements are processed, generating time slices based on predicates relevant for the basic truth (i.e. a set of assumptions that are correct) provided, e.g., by an expert system and/or a technician. For each time slice independently, relaxed abduction over the set of model axioms and observations made during that slice (also expressed as axioms) can be used to determine failed premises. In this step, user-defined weighting criteria can be used to guide the process (e.g. by making “near misses” in numerical values more likely than more significant deviations, or taking into account the reliability of certain data sources). The result is a set of solutions, one per time slice, where each solution expresses one statement of the form “if predicates p1, p2, . . . had been observed too, then rules r1, . . . rk would have fired as expected”.

These steps can also be described as follows:

(1) Rule Translation Step:
In this step, every diagnostic rule of the form “P1 AND P2 AND . . . IMPLIES D” is translated into a description logic axiom of the form “(hasFact SOME P1(AND (hasFact SOME P2) . . . SubClassOf (hasFact SOME D))”. This syntactical translation can be done automatically, introducing auxiliary concepts for concrete domain attributes if necessary.

(2) Data Translation and Time-Slicing Step:
From step (1), it is known which symptom assertions of the form “hasSymptom SOME S” are required. The proposed component parses the log file containing the sensor data line by line (assuming there is one entry per line in increasing temporal order) and produces symptom assertions on the fly. Every time, a new assertion is generated in this process, a new time slice is started (e.g., if the rule base only distinguishes temp>90 from temp<=90, a change of temp from 80 to 88 will not start a new time slice, whereas a change from 88 to 90.5 will).

(3) Debugging Step:
In this step, each time slice is encoded as a relaxed abduction problem (comprising: Theory, Assumptions, Observations), wherein
   the Theory is the translated rule base,
   the Observations correspond to “hasFact SOME Di” assertions for each head of a rule asserted to fire by the technician, and
   the set of Assumptions contains one “hasFact SOME Pi” axiom for each rule premise.
The events detected in the time slice under consideration are added as “hasFact SOME E” axioms to the Theory. Then, solving the resulting relaxed abduction problem either for general set inclusion dominance or for user-defined weights as motivated before, returns a set (Ai,Oi) encoding which premises are missing (the set Ai being a subset of Assumptions) for all rule heads in Oi (which corresponds to a subset of Observations) to fire. Details can be found in the Relaxed-Abduction Article as referenced above.

Moreover, the axiom-based representation of the rule base produced in step (1) can be used to easily check the complete rule base for consistency, i.e. to detect contradicting rules or rule nets by checking the consistency of the Theory. One example for a contradictive rule net can be denoted as follows:
a AND b AND c IMPLIES z
a AND b IMPLIES k
c AND k AND d IMPLIES NOT z

Hence, the translation of the complete model and data into description logic axioms is facilitated. This allows determining (in-)consistencies of the rule base using standard reasoning tasks of a description logic. For this task, highly optimized standard components are freely available, which enables implementing a reliable, provably correct and cost-efficient consistency check for rule bases.

Next, relaxed abduction over description logic models is used to generate explanations for the failure of certain conclusions. The relaxed abduction is a formally sound and complete reasoning procedure, so correctness of the proposed method can be ensured, justifying trust in the results generated. Furthermore, as it can be implemented on top of existing optimized reasoning systems, high performance can be provided. This way, the solution presented allows for a completely new debugging procedure for complex rule bases. This may be a suitable requisite for modifying or building a technical system, which is more reliable, flexible and/or more efficient. It may also provide a higher performance.

FIG. 1 shows a schematic diagram visualizing the concept of an automated debugging of a rule base 101.

The rule base 101 comprises a set of rules 102, 103 in a domain-specific rule language. The rules are transferred to or used by (see arrow 105) a transformation component 106 that utilizes a description logic (e.g., EL+) and provides parsing 107 and model creation 108 based on the rules obtained from the rule base 101. The rule base 101 and the transformation component 106 may be part of an offline transformation indicated by a dashed line 104.

As a result, the transformation component 106 provides axioms 109 to a debugging component 110, which may also use a description logic (e.g., EL+).

In addition, sensor data and a basic set of assumptions 117 (basic truth provided, e.g., by experts or operators) is gathered in a use-case-specific representation comprising several entries 118, 119, each containing data and output. Data and/or expectations 120 based on the sensor data and the basic set of assumptions 117 are conveyed to the debugging component 111.

The debugging component 110 conducts parsing 111 leading to several axioms 113, 114 and slicing 112 leading to several time slices 115, 116. The debugging component 110 conveys a query 121 comprising, e.g., a formal model and data and/or expectations for one time slice to a reasoning component 122, which also uses a description logic (e.g., EL+).

The reasoning component 122 conducts a deduction 123 and/or an abduction (in particular a relaxed abduction) 124 based on axioms and/or time slice data 125 to 127 and provides an answer 128 comprising, e.g., failed premises of the rules that are under consideration.

The rule base 101 and the sensor data and the basic set of assumptions 117 are part of a rule and fact export stage 129. The transformation component 106 is part of a transformation stage 130. The debugging component 110 and the reasoning component 122 are part of a debugging stage 131.

Enhancing an Administration of a Rule Base in a Technical System:

Administration of a rule base may comprise the following functionalities:

(a) Classification of rules on-the-fly (e.g., during operation):
Taxonomies are built among existing rules and equivalent rules are identified.
Existing rules are clustered into groups. For example, rules with regard to a specific type of machine or with regard to a particular problem domain are combined into a group, respectively.
Problems of sub-components to become connected with the overall system are determined.

(b) The consistency of the rules is checked on-the-fly:
A model-based mechanism for a definition of a normal situation is provided.
Inconsistencies are determined in an automated fashion based on such definition.
An automated explanation mechanism is provided for potential inconsistencies.

The solution presented in particular provides a deductive reasoning technique with open world assumption principle based on description logics. To achieve this goal, the following steps may be considered:
(1) A rule base is accessed, e.g., via an application programming interface (API) or by other means.
(2) The rules or the rule format used by the rule base is translated or mapped into a so-called rule interchange format (RIF), which
   could be a rule engine-independent XML-based rule representation format;
   could be a recommendation of the world wide web consortium (W3C),
   could have a well-defined syntax and semantics.
(3) The derived translation of the rules in RIF format can be serialized into an ontology format, e.g., according to or by using
   a syntax of OWL 2 description logic (OWL=web ontology language, details, see, e.g., http://en.wikipedia.org/wiki/Web_Ontology_Language),
   semantics of some appropriate description logic.

When the steps (1) to (3) above are completed, an administration functionality of the automated classification can be defined. In addition, consistency checking can be conducted as description logic reasoning tasks, using only modelling without actual programming (except, e.g., for interfaces, adapters or mappings).

Hence, the concept to obtain automated administration applies a deductive reasoning technique with an open world assumption principle based on description logics as suggested by the steps (1) to (3) above.

This enables extending an existing rule base at low cost and provides the functionalities of
on-the-fly automated classification of rules,
on-the-fly consistency checking of rules.

It is noted that in formal logic, the open world assumption (OWA) is the assumption that the truth-value of a statement is independent of whether or not it is known by any single observer or agent to be true. It is the opposite of the closed world assumption, which holds that any statement that is not known to be true is false. The open world assumption (OWA) is used in knowledge representation to codify the informal notion that in general no single agent or observer has complete knowledge, and therefore cannot make the closed world assumption. The OWA limits the kinds of inference and deductions an agent can make to those that follow from statements that are known to the agent to be true. In contrast, the closed world assumption allows an agent to infer, from its lack of knowledge of a statement being true, anything that follows from that statement being false. For further reference see, e.g., http://en.wikipedia.org/wiki/Open_world_assumption.

FIG. 2 shows an exemplary concept of an automated classification and consistency checking mechanism of a rule base 201.

The rule base 201 comprises rules 202 to 204 in a specific rule language. These rules are obtained from the rule base 201 (see arrow 205) and are processed by a translation component 206 into rules 207 to 209 into a rule interchange format (RIF), e.g., XML (extensible markup language).

The translation component provides the RIF 210 to a transformation component 211, which translates the rules using at least one of the following components: a parsing component 212, an object-based rule representation 213, a graph-based rule transformation 214 and a serialization 215.

The transformation component 211 conveys an invocation 216 to an OWL reasoning engine 217 comprising an OWL application programming interface (API) and a consistency check component 219 comprising several OWL axioms 220 in an OWL ontology. The consistency check component 219 allows consistency checking and classification of rules.

The rule base 201 is part of a rule export stage 221, the translation component 206 is part of a rule translation stage 222 and the transformation component 211 is part of a rule transformation stage 223. The OWL reasoning engine 217 is part of a rule consistency check and classification stage 224.

Results from the automated classification and/or the consistency check can be further processed by a description logic reasoning component which may be coupled to an ontology editor.

It is noted that the rules can be translated into known formats, e.g., Predictive Model Markup Language (PMML), OWL2, Prolog, CEP-formats (CEP: complex event processing), etc.

Although the invention is described in detail by the embodiments above, it is noted that the invention is not at all limited to such embodiments. In particular, alternatives can be derived by a person skilled in the art from the exemplary embodiments and the illustrations without exceeding the scope of this invention.

1. A method for processing rules governing functioning of a technical system, the method comprising:
receiving by a module comprising an automated data processor, rules of a rule base;
translating the rules into description logic axioms;
receiving sensor information at various times and further processing the description logic axioms based on the sensor information;
processing, by a reasoning component of the module, a query based on said description logic axioms; and
outputting a response to the query.

2. The method according to claim 1, wherein the rules of the rule base are translated into a rule interchange format and then the translated rules are transformed into the description logic axioms.

3. The method according to claim 1, wherein transforming the rules into description logic axioms comprises at least one of the following steps:
parsing of the rules;
providing an object-based rule representation;
providing a graph-based rule representation;
serializing the rules;
creating or modifying of at least one model based on the rules; and
transforming the rules into a description language.

4. The method according to claim 1, further comprising:
debugging by a debugging component, the description logic axioms;
complying said query for the reasoning component; and
wherein the debugging is performed prior to processing the query by the reasoning component.

5. The method according to claim 4, further comprising performing by the debugging component, at least one of the following steps:
parsing of the description logic axioms;
time slicing of data provided by at least one sensor and/or a set of basic assumptions; and
conveying the query to the reasoning component.

6. The method according to claim 4, wherein the debugging component utilizes a description language.

7. The method according to claim 1, further comprising performing, by the reasoning component at least one of the following steps:
conducting a consistency check by conducting a deduction;
generating an explanation by conducting a relaxed abduction.

8. The method according to claim 7, wherein at least one of the conducting, by said reasoning component, of the consistency check and the generating by the reasoning component, of the explanation is based on OWL axioms utilizing a description logic.

9. A device for processing rules of a technical system comprising a processing comprising an automated processor, the device comprising:
a module configured to receive rules of a rule base;
the module further configured to transform the rules of the rule base into axioms;
a reasoning component configured to process a query based on the description logic axioms; and
the module configured to output a response to the query.

10. The device of claim 9, wherein the device is at least one of an administration, a debugging and a diagnosis device of the technical system.

11. (canceled)

12. A computer-readable medium having computer-executable instructions adapted to cause a computer to perform the steps of the method according to claim 1.

13. The method of claim 3, wherein the description language is EL+.

14. The method of claim 6, wherein the description language is EL+.

15. The method of claim 8, wherein the description language is EL+.
